(19) United States
(12) Patent Application Publication
(10) Pub. No.: US 2025/0260363 A1
(43) Pub. Date: Aug. 14, 2025

(54) SOLAR MOUNTING SYSTEM HAVING INTEGRATED ELECTRICAL BONDING AND GROUNDING OF PHOTOVOLTAIC MODULES

(71) Applicant: Terrasmart, Inc., Cincinnati, OH (US)

(72) Inventors: Ben Urbanek, Cincinnati, OH (US); David Compaan, Columbus, OH (US)

(21) Appl. No.: 18/438,975

(22) Filed: Feb. 12, 2024

(51) Int. Cl. H02S 40/30; F16B 39/282; H02S 20/32; H02S 30/10

(52) U.S. Cl. CPC H02S 40/30; F16B 39/282; H02S 30/10; F16B 2200/93; H02S 20/32

(57) ABSTRACT

A solar mounting system includes at least one photovoltaic module (“PV module”) having a module frame and a support structure including at least one elongated support rail configured to support the at least one photovoltaic module (“PV module”). A fastener assembly or hardware stack is used to mount and secure the at least one PV module to the elongated support rail of the solar mounting system. The fastener assembly includes a fastener having a fastener head including at least one abutment surface that prevents rotation of the fastener during mounting of the PV module to the support structure, and, optionally, at least one projection that pierces a protective coating applied to the PV module to thereby establish an electrical bond and grounding of the PV module with the support structure during installation.

### FIELD OF THE INVENTION

The present invention relates generally to solar mounting systems and, more particularly, to bonding and grounding of photovoltaic modules that are mounted to a support structure of the solar mounting system.

### BACKGROUND

Solar mounting systems, designed for supporting varying numbers of photovoltaic modules (oftentimes referred to as “PV modules”), each having photovoltaic cells mounted in a rectangular module frame, are being installed as an alternative source of energy in many different settings, including smaller residential assemblies and larger commercial or utility assemblies. Especially in the context of larger solar mounting systems containing hundreds or even thousands of PV modules at a single installation site, it is desirable to simplify the process and cost of installing the PV modules onto the support structures of solar mounting systems that maintain the PV modules raised above a base surface such as a roof or ground. Each separate step that must be performed to reliably connect and mount a PV module onto the support structure must be repeated hundreds or possibly thousands of times in this context, which results in significant additional hours of labor needed during installation for any additional steps that become necessary when mounting each PV modules. Therefore, the designers of solar mounting systems continue to endeavor for quicker and simpler installation techniques that still adequately provide the structural support and electrical bonding and/or grounding connections required for each of the PV modules.

In one example, each of the PV modules mounted on a solar mounting system must be electrically bonded and/or grounded at conductive portions of the PV modules, such as the module frames which are typically manufactured of conductive aluminum. For safety purposes, any conductive portion of the PV modules should be bonded or connected to an electrically conductive path configured to safely conduct any electrical current in the conductive portions to ground potential and away from the sensitive photovoltaic cells and other energy-producing equipment on the solar mounting system. However, the grounding of module frames in solar mounting systems is made difficult by other design considerations necessary for solar mounting systems, such as the need to protect the conductive portion of the module frames from harsh environmental conditions that may lead to corrosion and deterioration of the module frames. As a result of this latter design consideration, module frames formed from aluminum or a similar metallic material may be anodized and/or coated to provide a protective coating, which may be electrically insulative, to resist environmental conditions and corrosion. For anodized aluminum, the anodizing process effectively coats the outer surface of the aluminum electrolytically with a protective coating that serves to protect the remainder of the aluminum material from environmental effects. But this protective coating makes it difficult to readily form an electrical bonding and/or grounding connection with the conductive portion of the module frames, which is required when grounding PV modules.

One common practice is to insert star washers or similar members between the module frames and the support structure to form an electrical bonding connection. A star washer is formed from flat metal stock so as to include a number of internal and/or external teeth that are twisted from the plane defined by the body of the star washer. These teeth tend to cut or dig into surfaces that the star washer abuts when the star washer is tightened between two adjacent components, such as the PV module frame and the underlying support structure. In this regard, the twisted or bent teeth in the star washer may provide a constant spring force resisting deformation back to a planar form. For a typical PV module, this may include up to four fasteners that should be provided with the additional star washer part. One example of solar panel mounting using star washers for grounding is shown in U.S. Pat. No. 7,971,398 to Tweedie.

The accurate alignment and insertion of these star washers for each PV module increases the complexity and cost of manufacturing larger solar mounting systems. Furthermore, the star washers must be carefully selected and tailored to reliably cut through the electrically insulative coating on the PV module frames being used. For example, if the star washers are not formed strong enough for the teeth to resist the compressive forces on the PV module and the supporting structure, the teeth may bend in some washers back to a planar state with the washer body, which causes the teeth not to adequately penetrate the electrically insulative coating provided on the PV module. Numerous efforts have been made to address these concerns with star washers, including thickening the star washer and/or using a modified bonding washer commercially referred to as a WEEB, both of which are described in U.S. Pat. No. 8,092,129 to Wiley et al. In other systems, different types of structures have been used in place of star washers, such as the grounding clips shown in U.S. Patent Publication No. 2012/0097816 to Tamm et al., and the grounding clamps shown in U.S. Pat. No. 8,181,926 to Magno, Jr., et al.

However, each of these alternatives to star washers still requires additional installation work and cost to add these separate electrical bonding and grounding components during the construction of a solar mounting system. Even if several of these alternative bonding and grounding components function better, or are installed more rapidly than a grounding lug or a star washer, there may be a need to source these components from different vendors, and these components may add additional costs to the solar mounting system installation. For example, a star washer that may cost a few cents, or a modified bonding washer that may cost a bit more, are minimal in costs by themselves, but these parts are required for each connection made to the PV modules, and this incremental cost aggregates into a significant added expense for larger solar mounting systems in which thousands of connections are to be made.

There is a need, therefore, for a solar mounting system and method for installing a solar mounting system that further simplify the electrical bonding and grounding process for each PV module, thereby reducing installation costs and improving performance of the solar mounting system.

### SUMMARY OF THE INVENTION

The present invention overcomes the foregoing and other shortcomings and drawbacks of solar mounting systems heretofore known. While the invention will be described in connection with certain embodiments, it will be understood that the invention is not limited to these embodiments. On the contrary, the invention includes all alternatives, modifications and equivalents as may be included within the spirit and scope of the present invention.

According to one aspect of the present invention, a fastener is provided for use in mounting a photovoltaic module (“PV module”) to a support structure of a solar mounting system. The PV module has a module frame including a mounting flange and an upstanding mounting box.

According to one embodiment, the fastener includes a fastener head having at least one abutment surface, wherein the at least one abutment surface is configured to engage the upstanding mounting box of the module frame in response to a rotational force being applied to the fastener during mounting of the PV module to the support structure of the solar mounting system. The engagement of the at least one abutment surface with the upstanding mounting box of the module frame prevents rotation of the fastener.

The fastener includes a threaded fastener shank that extends in an axial direction from the fastener head and is configured to extend through the mounting flange of the PV module to secure the PV module to the support structure.

In one embodiment, the fastener includes at least one projection that extends in the axial direction from an underside of the fastener head that is spaced radially from the threaded fastener shank. The at least one projection is configured to pierce a protective coating applied to the mounting flange of the module frame in response to a tightening of the fastener to establish an electrical bonding and grounding of the PV module with the support structure during installation of the PV module onto the solar mounting system. In this way, the fastener provides integrated electrical bonding and grounding of the PV module with the support structure of the solar mounting system during installation of the PV module.

The fastener may include a plurality of projections that extend in the axial direction from the underside of the fastener head that are spaced radially from the threaded fastener shank.

The plurality of projections may be spaced from each other in a circumferential direction, with a plurality of projections being equally spaced radially from the threaded fastener shank. Alternatively, one or more of the plurality of projections may be inequally spaced radially from the threaded fastener shank.

In one embodiment, the threaded fastener shank is threaded along its entire length. Alternatively, the threaded fastener shank includes a threaded portion and an unthreaded portion along its length.

According to one embodiment, the fastener head includes a partially circular circumference extending between a pair of opposite ends of the partially circular circumference, with the at least one abutment surface extending between the opposite ends of the partially circular circumference. In one embodiment the at least one abutment surface may extend linearly between the pair of opposite ends of the partially circular circumference.

According to one aspect of the present invention, the at least one abutment surface is configured to engage the upstanding mounting box of the module frame in response to a rotational force being applied to the fastener so that the engagement of the at least one abutment surface with the upstanding box of the module frame prevents rotation of the fastener during installation of the PV module onto the support structure of the solar mounting system.

The fastener may comprise a fastener bolt and a nut configured to engage the bolt to apply a tightening force to the fastening bolt so that the at least one projection pierces the protective coating applied to the mounting flange of the module frame to establish the electrical bond and grounding of the PV module with the support structure.

According to another aspect of the present invention, a solar mounting system is provided comprising at least one PV module having a module frame including a mounting flange and an upstanding mounting box. The solar mounting system also comprises a support structure including a plurality of support members configured to support the at least one PV module above a base surface and at least one elongated support rail operatively supported by the plurality of support members.

According to one aspect of the present invention, the solar mounting system includes at least one fastener comprising a fastener head having at least one abutment surface that is configured to engage the upstanding mounting box of the module frame in response to a rotational force being applied to the fastener during mounting of the PV module to the support structure of the solar mounting system. The engagement of the at least one abutment surface with the upstanding mounting box of the module frame prevents rotation of the fastener.

The fastener includes a threaded fastener shank extending in an axial direction from the fastener head that is configured to extend through the PV module and the at least one elongated support rail of the support structure to secure the PV module to the at least one elongated support rail of the support structure.

The fastener may include at least one projection that extends in the axial direction from the radially from the threaded fastener shank. The at least one projection is configured to pierce a protective coating applied to the mounting flange of the module frame in response to a tightening of the fastener to establish an electrical bond and grounding of the PV module with the support structure during installation of the PV module onto the solar mounting system. In this way, the fastener provides integrated electrical bonding and grounding of the PV module with the support structure of the solar mounting system during installation of the PV module.

In one embodiment, the fastener includes a plurality of projections that extend in the axial direction from the underside of the fastener head that are spaced radially from the threaded fastener shank.

The plurality of projections may be spaced from each other in a circumferential direction with the plurality of projections being equally spaced radially from the threaded fastener shank. Alternatively, one or more of the plurality of projections may be inequally spaced radially from the threaded fastener shank.

In one embodiment, the threaded fastener shank is threaded along its entire length. Alternatively, the threaded fastener shank includes a threaded portion and an unthreaded portion along its length.

In one embodiment, the mounting flange of the module frame includes at least one mounting aperture formed therethrough and at least one elongated support rail includes at least one fastener aperture formed therethrough, with the at least one mounting aperture and the at least one fastener aperture being configured to receive the at least one fastener to secure the PV module to the at least one elongated support rail of the support structure.

According to yet another aspect of the present invention, a method of installing a solar mounting system is provided that includes the steps of mounting a support structure of the solar mounting system in a base surface, with the support system including a plurality of support members and at least one elongated support rail operatively supported by the plurality of support rails.

The method further includes the step of securing at least one PV module having a module frame including a mounting flange and an upstanding mounting box to the at least one elongated support rail with at least one fastener.

The at least one fastener comprises a fastener head having at least one abutment surface that is configured to engage the upstanding mounting box of the module frame in response to a rotational force being applied to the fastener during mounting of the PV module to the support structure of the solar mounting system. The engagement of the at least one abutment surface with the upstanding mounting box of the module frame prevents rotation of the fastener.

The fastener includes a threaded fastener shank extending in an axial direction from the fastener head that is configured to extend through the PV module and the at least one elongated support rail of the support structure to secure the PV module to the at least one elongated support rail of the support structure.

The fastener may include at least one projection that extends in the axial direction from the radially from the threaded fastener shank. The at least one projection is configured to pierce a protective coating applied to the mounting flange of the module frame in response to a tightening of the fastener to establish an electrical bond and grounding of the PV module with the support structure during installation of the PV module onto the solar mounting system.

In one embodiment, the fastener head includes a partially circular circumference extending between a pair of opposite ends of the partially circular circumference with the at least one abutment surface extending between the pair of opposite ends of the partially circular circumference.

The at least one abutment surface may extend linearly between the pair of opposite ends of the partially circular circumference.

According to one embodiment, the at least one fastener comprises a fastener bolt, and a nut configured to engage the bolt to apply a tightening force to the fastening bolt so that the at least one projection pierces the protective coating applied to the mounting flange of the module frame to establish the electrical bond and grounding of the photovoltaic module with the support structure.

The present invention thereby provides a solar mounting system and method of installing a solar mounting system that provides integrated electrical bonding and grounding of at least one PV module.

These and other advantages of the present invention will become more readily apparent from the following detailed description taken in conjunction with the drawings herein.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a disassembled perspective view of a solar mounting system according to one embodiment of the present invention.

FIG. 2 is an exploded view of the connection between an elongated support rail or purlin of a solar mounting system and a PV module using a fastener assembly or hardware stack of the prior art.

FIG. 2A is a cross-sectional view of the connection between the elongated support rail or purlin and the PV module of FIG. 2, as taken along line 2A-2A in FIG. 2.

FIG. 3 is an exploded view of the connection between an elongated support rail or purlin of a solar mounting system and a PV module using a fastener assembly or hardware stack according to an exemplary embodiment of the present invention.

FIG. 3A is a cross-sectional view of the connection between the elongated support rail or purlin and the PV module of FIG. 3, as taken along line 3A-3A in FIG. 3, showing integrated electrical bonding and grounding of the PV module during mounting of the PV module to the solar mounting system.

FIG. 4 is a cross-sectional view as taken along lines 4-4 in FIG. 3.

FIG. 5 is a top perspective view of the fastener shown in FIGS. 3, 3A and 4.

FIGS. 6-8 are various side elevational views of the fastener shown in FIGS. 3, 3A, 4 and 5.

FIG. 9 is a top plan view of the fastener shown in FIGS. 3, 3A, 4 and 5.

FIG. 10 is a bottom plan view of the fastener shown in FIGS. 3, 3A, 4 and 5.

### DETAILED DESCRIPTION

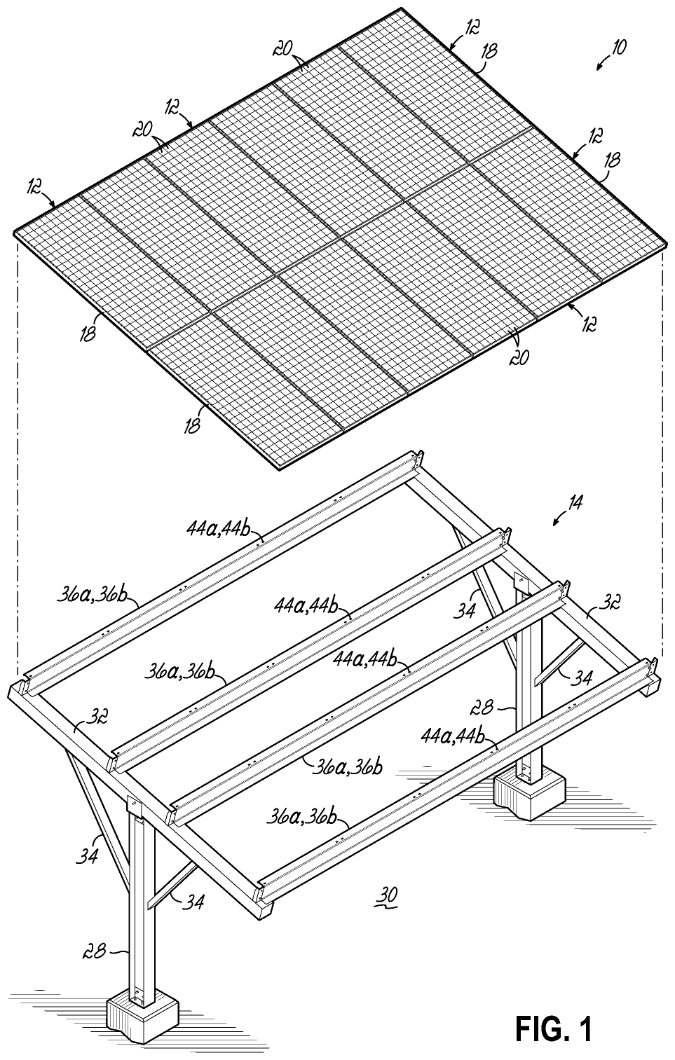

With reference to FIGS. 1, 3, 3A and 4, an exemplary embodiment of a solar mounting system 10 according to the principles of the present invention is shown that enables mounting and integrated electrical bonding and grounding of a plurality of photovoltaic modules (“PV modules”) 12 to the solar mounting system 10. The solar mounting system 10 shown in FIG. 1 includes twelve PV modules 12 arranged in a 6-by-2 grid (e.g., in a portrait orientation) on top of a support structure 14 that is tailored in size to the number of PV modules 12 to be supported. It will be understood that the particular number and arrangement of the PV modules 12 can be modified in other embodiments, such as in larger assemblies (e.g., up to hundreds or even thousands of PV modules 12) used for commercial or utility power generation, or in other arrangements (e.g., in a landscape orientation), without departing from the spirit and scope of the present invention.

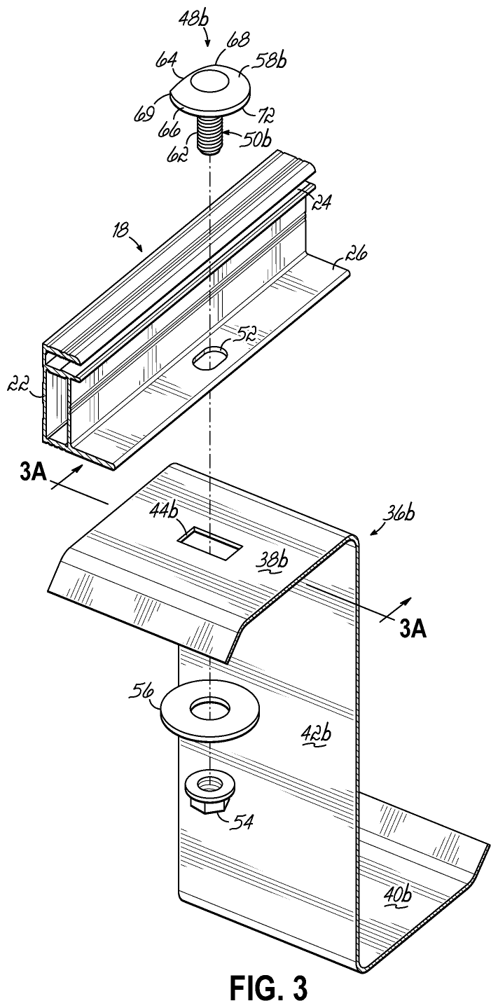

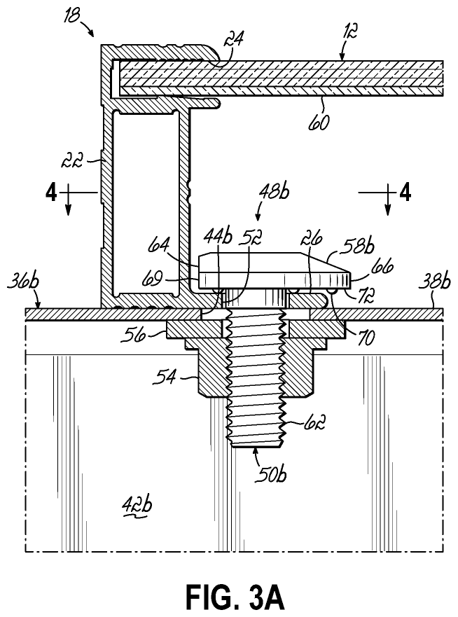

The support structure 14 of the solar mounting system 10 in this embodiment is advantageous because integrated electrical bonding and grounding of each of the PV modules 12 is established, without taking additional steps or installing additional electrical bonding and grounding components during mounting of the PV modules 12 to the support structure, with fasteners 50b (FIGS. 3, 3A, 4 and 5-10) according to one embodiment of the present invention as will be described in greater detailed below. This integrated electrical bonding and grounding occurs even when the PV modules 12 include module frames 18 that made of conductive material and coated with a protective coating (which may be electrically insulative, in some embodiments). In this regard, the support structure 14 acts as a conductive path to ground potential for each of the PV modules 12, thereby providing the safety and electrical bonding and/or grounding that is desirable when constructing the solar mounting system 10.

The solar mounting system 10, and its method of assembly described in further detail below, do not require the use and installation of separate grounding equipment, including, but not limited to, star washers, grounding clips, WEEB devices, grounding lugs, and copper ground wiring. Accordingly, the materials and installation cost for mounting PV modules 12 to the solar mounting system 10 are typically reduced compared to several known electrical bonding and grounding approaches of the prior art. However, it will be understood that the integrated electrical bonding and grounding with the support structure 14 may also be used in combination with these types of separate electrical bonding and grounding components in non-illustrated embodiments consistent with the scope of the present invention.

With particular reference to FIGS. 1, 3, 3A and 4, the specific details of exemplary PV modules 12 and the support structure 14 are shown in further detail. To this end, each of the PV modules 12 in this exemplary embodiment is a rectangular, framed PV module 12 having one or more photovoltaic cells 20 surrounded by the module frame 18. The module frame 18 is shown and described in greater detail below with the module frame 18 including an upstanding module box 22 having an upper channel 24 for receiving and retaining the photovoltaic cells 20, and a lower mounting flange 26 spaced from the upper channel 24 and configured to be connected to the support structure 14 to mount the PV module 12 onto the solar mounting system 10. The dimensions of the height and width of the module box 22, and the length of the mounting flange 26, may vary according to the particular PV module manufacturer and/or manufacturer models as well.

The module frame 18 is typically manufactured of a metallic conductive material such as aluminum, but this conductive material is typically coated with a protective coating (not shown) in the figures, such as by applying a polymeric coating or by anodizing the outer exposed layers of the conductive material when the conductive material chosen is aluminum. In the anodizing example, the process of anodizing modifies the outer exposed layers of the conductive material into a coating substantially surrounding the conductive material. Other methods of providing a protective coating on the module frame 18 may also be used in accordance with the scope of the present invention. This protective coating prevents the module frame 18 from being exposed to the sometimes harsh environmental conditions where the solar mounting system 10 is installed, thereby limiting or preventing deterioration effects such as corrosion. Because this coating may be electrically insulative, any electrical bonding and grounding features must cut through this coating to provide the necessary electrical bonding contact with the underlying conductive material.

With continued reference to FIG. 1, the exemplary support structure 14 includes a plurality of support members, such as a pair of spaced apart and vertically oriented support posts 28 mounted to a base surface 30, and a pair of spaced apart top chords 32 supported by the pair of vertical oriented support posts 28, respectively, and dual knee braces 34. The support structure 14 further includes a plurality of spaced apart elongated support rails 36a, 36b that are supported at their opposite end by the pair of the top chords 32 so that the plurality of elongated support rails 36a, 36b extend transversely to the pair of top chords 32, thereby effectively forming a grid for receiving and mounting the PV modules 12 in the intended positions shown. Each of the plurality of elongated support rails 36a, 36b is also referred to as elongated Z-shaped purlins 36a, 36b throughout the following description, but it will be understood that these elongated support rails 36a, 36b may take a different form than being a “purlin” in other embodiments consistent with the scope of the present invention. Similarly, the following description of the plurality of support members of the solar mounting system 10 is an exemplary embodiment only, as each of these elements may be reshaped or reconfigured for different installations and needs of a solar mounting system 10. Each of the support posts 28, top chords 32, knee braces 34, and elongated purlins 36a, 36b may be formed from galvanized steel or tubing in the exemplary embodiment, but other rigid materials may be used without departing from the scope of the invention.

In one embodiment, the support structure 14 may be essentially the same as, or similar to, Applicant's RBI GLIDE Wave™ fixed-tilt solar mounting system, by way of example, which is commercially available from Terrasmart, Inc. located in Cincinnati, Ohio. As will be understood by those skilled in the art, the solar mounting system 10 is typically installed with its longitudinal axis aligned in an east-west orientation, with the pair of top chords 32 and the plurality of elongated support rails 36a, 36b oriented in a tilted plane for supporting the plurality of PV modules 12 in a preferred solar collecting position. However, it will be understood that the present invention is not limited to fixed-tilt mounting systems, as the present invention is equally applicable to solar mounting systems that track the apparent path of the sun, oftentimes referred to as “solar trackers.”

Prior to the present invention, a significant advance was made for providing electrical bonding and grounding of a PV module frame 18 to a support structure 14 during installation of the PV module 12 as fully described in Applicant's U.S. Pat. No. 10,432,132 which is incorporated herein by reference in its entirety.

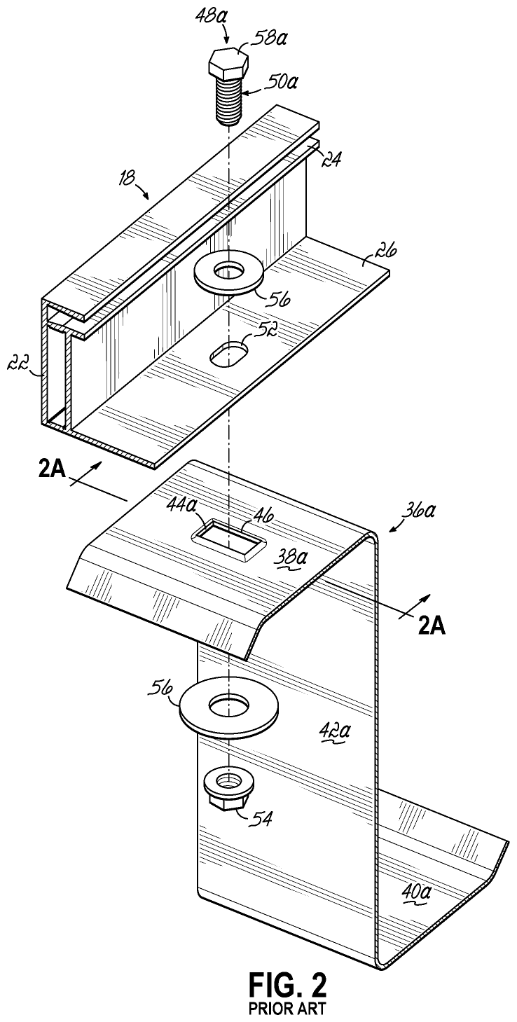

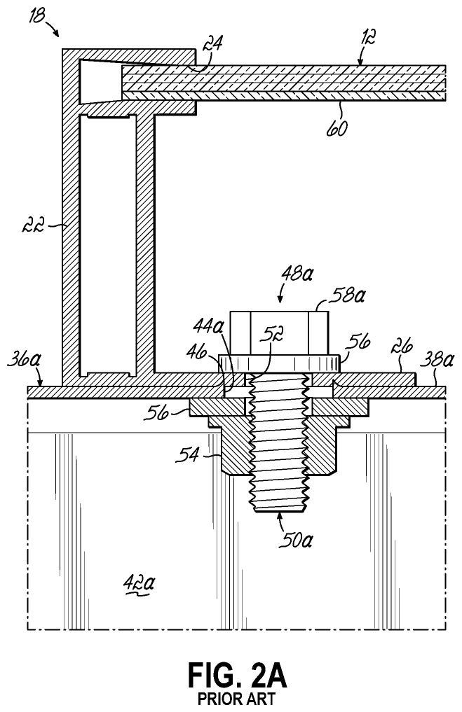

As fully described in Applicant's U.S. Pat. No. 10,432,132 incorporated herein, and as shown with reference to FIGS. 2 and 2A (each labeled as prior art), each elongated purlin 36a (one shown) comprises an elongated generally Z-shaped beam or rail having a longitudinal length that is oriented transverse to the top chord rails 32 (see FIG. 1). More particularly, each elongated purlin 36a (one shown) includes a first supporting surface 38a and a second supporting surface 40a extending generally parallel, and spaced from each other, on opposite ends of a central wall 42a which extends transversely to the first and second supporting surfaces 38a, 40a. The first supporting surface 38a is configured to abut the module frames 18 of the PV modules 12 as shown in FIGS. 2 and 2A, while the second supporting surface 40a is positioned to abut the top chords 32 (see FIG. 1) when the elongated purlins 36a are installed on the support structure 14. While Z-shaped purlins 36a, 36b are illustrated herein, it will be appreciated that the purlins 36a, 36b may define a different cross-sectional shape in other embodiments consistent with the scope of the present invention, including but not limited to: C-shaped, tube-shaped, hat-shaped, or I-beam shaped.

Once each of the elongated purlins 36a is mounted and secured into position on the top chords 32 as shown in FIG. 1, the assembly of the support structure 14 is complete and the support structure 14 is ready for mounting of the PV modules 12.

With continued reference to FIGS. 2 and 2A (each labeled as prior art), each of the elongated purlins 36a (one shown) includes at least one fastener aperture 44a having a raised edge 46 on the first supporting surface 38a of the elongated purlin 36a located proximate to the fastener aperture 44a that is configured to make an electrical bonding contact with the mounting flange 26 of the PV module 12. The fastener aperture 44a, having the raised edge 46, defines an electrical bonding and grounding structure formed from the material of the elongated purlin 36a itself for electrically bonding and grounding the PV modules 12 when they are connected to the purlins 36a of the solar mounting system 10.

As shown most clearly in FIG. 2 (labeled as prior art), the raised edge 46 projects upwardly from the first supporting surface 38a such that when the lower mounting flange 26 of the module frame 18 is brought into contact with the first supporting surface 38a of the Z-shaped purlin 36a, and sufficiently tightened by a fastener assembly or hardware stack 48a, the raised edge 46 cuts into the module frame 18 to make a reliable electrical bonding and grounding connection. Therefore, even when the module frame 18 comprises a conductive material coated with a protective coating (not shown), the elongated purlin 36a itself is still configured to make direct electrical bonding and/or grounding contact with the module frame 18 by cutting through the protective coating (not shown) with the raised edge 46.

Thus, the electrical bonding and/or grounding of the PV module 12 is performed during secured mounting with the elongated purlin 36a of the support structure 14 rather than with additional parts or equipment commonly used for grounding purposes as described above. Accordingly, the elongated purlin 36a serves both as a structural support for multiple PV modules 12 as well as an electrical bonding and grounding feature. It will be understood that each elongated purlin 36a may include a series of the fastener apertures 44a located along the length of the purlins 36a for mounting and securing a plurality of PV modules 12 as shown in FIG. 1 and fully described in U.S. Pat. No. 10,432,132 previously incorporated herein by reference.

The coupling of the PV module 12 and the elongated purlin 36a in this embodiment is shown in a fully assembled state in FIG. 2A (labeled as prior art).

As shown in FIGS. 2 and 2A (both labeled as prior art), the PV module 12 and the elongated purlin 36a are fastened together via the fastener assembly or hardware stack 48a including a threaded fastener in the form of a hex bolt fastener 50a. The bolt fastener 50a is configured to be inserted through a mounting aperture 52 formed through the lower mounting flange 26 of the module frame 18 and through the fastener aperture 44a formed through the first supporting surface 38a of the elongated purlin 36a. In one embodiment, the mounting aperture 52 of the module frame 18 may have a circular or oval shape, by way of example. The fastener aperture 44a may have a rectangular shape as shown, by way of example. It will be appreciated that the mounting aperture 52 and the fastener aperture 44a may be reshaped or resized according to a particular solar mounting system requirement.

The fastener assembly 48a further includes a collar nut 54 that is threadably engaged with the hex bolt fastener 50a and can be tightened to draw the mounting flange 26 of the PV module 12 and the first supporting surface 38a of the elongated purlin 36a together into contact. The fastener assembly 48a may include one or more optional planar washers 56 which may be inserted between a bolt head 58a of the hex bolt fastener 50a and the module flange 26 and/or between the collar nut 54 and the first supporting surface 38a of the elongated purlin 36a. The planar washers 56, when used, increase the surface area of contact for applying the tightening forces from the bolt head 58a and the collar nut 54 to the PV module 12 and the elongated purlin 36a. However, other embodiments of the solar mounting system 10 may omit these planar washers 56 without affecting the functionality of the coupling when the bolt head 58a and/or collar nut 54 are sufficiently large compared to the mounting aperture 52 formed through the mounting flange 26 of the module frame 18 and/or the fastener aperture 44a formed through the first supporting surface 38a of the elongated purlin 36a.

As a result of the grounding feature of this embodiment being a raised edge 46 formed proximate the fastener aperture 44a of the elongated purlin 36a, the fastener assembly 48a by itself is sufficient to both fasten the PV module 12 in position securely on the support structure 14 of the solar mounting system 10 as well as establish the necessary electrical bonding and grounding of the conductive material in the module frame 18.

With continued reference to FIGS. 2 and 2A (both labeled as prior art), the module frame 18 includes spacing between the upper channel 24 which retains the photovoltaic cells 20 and the mounting flange 26 that includes the mounting aperture 52. This spacing enables an installer to reach between the lower surface 60 of the photovoltaic cells 20 and the elongated purlin 36a to insert the hex bolt fastener 50a into the fastener aperture 44a and mounting aperture 52. Similarly, the shape of the elongated purlin 36a (which may be different shapes as described above) provides significant spacing underneath the first supporting surface 38a so that an installer can hold and manipulate the collar nut 54 that is threadably engaged with the hex bolt fastener 50a. Thereafter, the installer is able to hold and retain the bolt head 58a stationary with a tool (not shown) inserted below the lower surface 60 of the PV module 12 while sufficiently tightening the collar nut 54 on the hex bolt fastener 50a with another tool (not shown).

Referring now to FIGS. 3, 3A, 4, and 5-9, a fastener 50b is shown, which is the focus of the present invention, for mounting and securing a PV module 12 to the support structure 14 of the solar mounting system 10, where like parts are represented by the same reference numerals as used in FIGS. 1, 2 and 2A, and where modified parts are designated with an additional character “b” instead of the additional character “a” used in FIGS. 1, 2 and 2A,

As will be described in detail below, the fastener 50b according to the exemplary embodiment is part of a fastener assembly or hardware stack 48b (FIGS. 3 and 3A) that is used to securely mount the PV module 12 to the elongated purlin 36b of the support structure 14 and may also establish direct electrical bonding and/or grounding contact with the module frame 18 by piercing through the protective coating (not shown) applied to the mounting flange 26. Each elongated purlin 36b includes a first supporting surface 38b and a second supporting surface 40b extending generally parallel, and spaced from each other, on opposite ends of a central wall 42b which extends transversely to the first and second supporting surfaces 38b, 40b.

As shown in FIGS. 3, 3A, and 5-9, the fastener 50b comprises a threaded fastener having a fastener head 58b and a threaded fastener shank 62 extending in an axial direction from the fastener head 58b. In one embodiment, the threaded fastener shank 62 is threaded along the entire length of the shank 62, while in an alternative embodiment, the threaded fastener shank 62 includes a threaded portion and an unthreaded portion along its length.

During installation of the PV module 12 onto the support structure 14 of the solar mounting system 10, the fastener 58b is inserted through the fastener aperture 44b formed through the first supporting surface 38b of the elongated purlin 36b and through the mounting aperture 52 formed through the mounting flange 26 of the module frame 18. The elongated purlin 36b of this embodiment differs from the elongated purling 36a described in FIGS. 2 and 2A only in that the raised edge 46 formed around the fastener aperture 44a shown in FIG. 2 is removed.

The fastener assembly or hardware stack 48b further includes a collar nut 54 that is threadably engaged with the fastener 50b and can be tightened to draw the mounting flange 26 of the PV module 12 and the first supporting surface 38b together into contact. As shown in FIGS. 3 and 3A, the fastener assembly or hardware stack 48b may include one or more optional planar washers 56 which may be inserted between the fastener head 58b of the threaded fastener 50b and the mounting flange 26 and/or between the collar nut 54 and the first supporting surface 38b of the elongated purlin 36b.

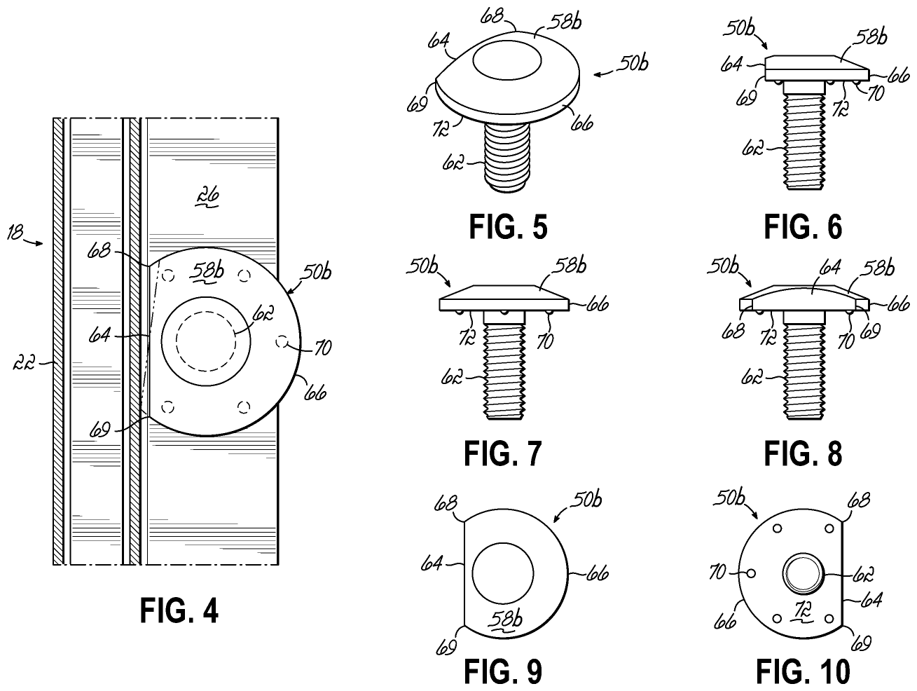

According to one aspect of the present invention as shown in the exemplary embodiment of FIGS. 3, 3A, 4 and 5-9, the fastener head 58b includes at least one abutment surface 64 which is configured to engage the upstanding mounting box 22 of the module frame 18 in response to a rotational force being applied to the fastener 50b when the collar nut 54 is either being tightened to secure the PV module 12 to the support structure 14 of the solar mounting system 10, or when the collar nut 54 is being loosened or removed during adjustment or removal of the PV module 12 (see FIG. 4) to prevent rotation of the threaded fastener 50b.

In one embodiment, the fastener head 58b includes a partially circular circumference 66 which extends between a pair of opposite ends 68, 69 of the partially circular circumference 66 as shown most clearly in FIGS. 4, and 8-10. It will be understood, however, that other shapes or configurations of the fastener head 58b are possible as well without departing from the spirit and scope of the present invention.

Further referring to the embodiment of FIG. 3, 3A and 4-10, the at least abutment surface 64 extends between the pair of opposite ends 68, 69 of the partially circular circumference 66. In one embodiment, the at least one abutment surface 64 extends linearly between the pair of opposite ends 68, 69 of the partially circular circumference 66, although other shapes or configurations of the at least one abutment surface 64 are possible as well.

As shown in FIG. 4, when the collar nut 54 is being tightened by the installer, this causes a counterclockwise rotation of the threaded fastener 50b, including its fastener head 58b. As the fastener head 58b rotates in the counterclockwise direction, the at least one abutment surface 64 engages the upstanding mounting box 22 of the module frame 18 in response to the counterclockwise rotational force being applied to the fastener 50b to prevent rotation of the threaded fastener 50b.

Conversely, as also shown in FIG. 4, when the collar nut 54 is being loosened or removed by the installer, this causes a clockwise rotation of the threaded fastener 50b, including its fastener head 58b. As the fastener head 58b rotates in the clockwise direction, the at least one abutment surface 64 engages the upstanding mounting box 22 of the module frame 18 in response to the clockwise rotational force being applied to the fastener 50b to prevent rotation of the threaded fastener 50b.

The at least one abutment surface 64 may provide multiple points of contact of the fastener head 58b with the upstanding mounting box 22 of the PV module 12, such as shown in the exemplary embodiment shown in FIG. 4 or, alternatively, the at least one abutment surface 64 may provide a line of contact of the fastener head 58b with the upstanding mounting box 22 of the PV module 12 in other embodiments (not shown). This line of engagement may be provided if the fastener head 58b is made sufficiently large enough such that the at least one abutment surface 64 engages the upstanding mounting box 22 when the fastener 50b is initially installed. Alternatively, this line of engagement may be provided if either the upstanding mounting box 22 has a sufficiently large enough width and/or the mounting flange 26 of the module frame 18 has a sufficiently small enough length such that the at least one abutment surface 64 engages the upstanding mounting box 22 when the fastener 50b is initially installed.

In this way, the collar nut 54 can be either tightened on the threaded fastener 50b to secure the PV module 12 onto the support structure 14 of the solar mounting system 10, or loosened or removed from the threaded fastener 50b for adjustment or removal of the PV module 12, without requiring the installer to use a tool beneath the lower surface 60 of the photovoltaic cells 20 to hold the fastener head 58b during the tightening or loosing process.

As will be readily understood by those skilled in the art, this feature of the fastener 50b of the present invention greatly simplifies the installation process for mounting and securing PV modules 12 to the support structure 14 of the solar mounting system 10 as typically at least four fastener assemblies or hardware stacks are used to secure each PV module 12, and most solar installations employ hundreds or even thousands of PV modules 12. With this feature of the fastener 50b of the present invention, the risk of damaging the PV modules 12 during the installation process is greatly reduced as the installer is no longer required to insert a tool beneath the lower surface 60 of the photovoltaic cells 20 to hold the fastener head 58b during the tightening or loosening process.

According to another aspect of the present invention as shown in the exemplary embodiment of FIGS. 3, 3A, 4 and 5-10, the fastener head 58b may, optionally, include one or more projections 70 that extend in the axial direction from an underside 72 of the fastener head 58b (see FIGS. 3A, 4, 6-8 and 10). The one or more projections 70 are spaced radially from the threaded shank 62 and are configured to pierce the protective coating (not shown) applied to the mounting flange 26 of the module frame 18 in response to a sufficient tightening of the fastener 50b to establish an electrical bond and grounding of the PV module 12 with the support structure 14 of the solar mounting system 10.

In one embodiment, the projections 70 are spaced from each other in a circumferential direction as shown in FIGS. 3A, 4, 6-8 and 10. As shown in these figures, the plurality of projections 70 are equally spaced from each other in the circumferential direction between the first and last projections 70. However, it is possible that the projections 70 may not be spaced from each other in the circumferential direction, and may also not be equally spaced from each other in the circumferential direction between the first and last projections 70, without departing from the spirit and scope of the present invention.

In one embodiment as shown in FIGS. 3A, 4, 6-8 and 10, the projections 70 are equally spaced radially from the threaded shank 62. In an alternative embodiment, it will be understood that one of more of the plurality of projections 70 may be inequally spaced radially from the threaded shank 62 within the scope of the present invention.

The fastener 50b may be sized as a M6 (or ¼″ equivalent) or M8 (or 5/16″ equivalent) fastener, by way of example, and may be formed by a cold-forging process known to those skilled in the art from an A2 stainless steel blank or other suitable metal material.

The protrusions 70, which are formed on the underside 72 of the fastener head 58a during the cold-forging process, may be configured as detents or protuberances having a somewhat blunt, rounded or sharp tip or point at their respective ends that is sufficiently configured to pierce the protective coating (not shown) applied to the mounting flange 26 of the PV module 12 when the fastener 50b of the present invention is sufficiently tightened to secure installation of the PV module 12 onto the support structure 14 of the solar mounting system 10.

In one embodiment, the projections 70 may have a diameter of about 1.25+0.25 mm, and a height of about 0.5 mm, although other shapes, sizes, and configurations of the projections 70 are possible as well within the spirit and scope of the present invention.

As a result of the grounding feature of the present invention, i.e., the one or more projections 70 formed on the underside 72 of the fastener head 58b, the fastener 50b forming part of the fastener assembly or hardware stack 48b, is sufficient to both fasten the PV modules 12 in position securely on the support structure 14 as well as establish the necessary electrical bonding and grounding of the conductive material in the module frame 18.

In this way, the fastener 50b provides mounting, and also optionally integrated electrical bonding and grounding, of the PV module 12 with the support structure 14 of the solar mounting system 10 during installation of the PV modules 12.

As those skilled in the art will readily appreciate, this mounting, and integrated electrical bonding and grounding, provided by the fastener 50b of the present invention reduces the amount of installation work required to mount, and optionally electrically bond and ground, the PV modules 12.

While the present invention has been illustrated by the description of exemplary embodiments thereof, and while these embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be from such details without departing from the scope or spirit of the general inventive concept.

What is claimed is:

1. A fastener for use in mounting a photovoltaic module to a support structure of a solar mounting system, the photovoltaic module having a module frame including a mounting flange and an upstanding mounting box, the fastener comprising:
a fastener head having at least one abutment surface, wherein the at least one abutment surface is configured to engage the upstanding mounting box of the module frame in response to a rotational force being applied to the fastener so that the engagement of the at least one abutment surface with the upstanding box prevents rotation of the fastener; and
a threaded fastener shank extending in an axial direction from the fastener head and being configured to extend through the mounting flange of the photovoltaic module to secure the photovoltaic module to the support structure.

2. The fastener of claim 1, further comprising at least one projection extending in the axial direction from an underside of the fastener head and spaced radially from the threaded fastener shank, wherein the at least one projection is configured to pierce a protective coating applied to the mounting flange of the module frame in response to a tightening of the fastener to establish an electrical bond and grounding of the photovoltaic module with the support structure.

3. The fastener of claim 1, further comprising a plurality of projections extending in the axial direction from the underside of the fastener head and spaced radially from the threaded fastener shank.

4. The fastener of claim 3, wherein the plurality of projections are spaced from each other in a circumferential direction.

5. The fastener of claim 4, wherein the plurality of projections are equally spaced radially from the threaded fastener shank.

6. The fastener of claim 3, wherein one or more of the plurality of projections are inequally spaced radially from the threaded fastener shank.

7. The fastener of claim 1, wherein the threaded fastener shank is threaded along its entire length.

8. The fastener of claim 1, wherein the threaded fastener shank included a threaded portion and an unthreaded portion along its length.

9. The fastener of claim 1, wherein the fastener head includes a partially circular circumference extending between a pair of opposite ends of the partially circular circumference.

10. The fastener of claim 9, wherein the at least one abutment surface extends between the pair of opposite ends of the partially circular circumference.

11. The fastener of claim 10, wherein the at least one abutment surface extends linearly between the pair of opposite ends of the partially circular circumference.

12. The fastener of claim 1, wherein the fastener comprises:
a fastener bolt; and
a collar nut configured to engage the bolt to apply a tightening force to the fastening bolt so that the at least one projection pierces the protective coating applied to the mounting flange of the module frame to establish the electrical bond and grounding of the photovoltaic module with the support structure.

13. A solar mounting system, comprising:
at least one photovoltaic module having a module frame including a mounting flange and an upstanding mounting box;
a support structure including a plurality of support members configured to support the at least one photovoltaic module above a base surface and at least one elongated support rail operatively supported by the plurality of support members; and
at least one fastener comprising:
a fastener head having at least one abutment surface, wherein the at least one abutment surface is configured to engage the upstanding mounting box of the module frame in response to a rotational force being applied to the fastener so that the engagement of the at least one abutment surface with the upstanding box prevents rotation of the fastener;
a threaded fastener shank extending in an axial direction from the fastener head and being configured to extend through the mounting flange of the at least one photovoltaic module and the at least one elongated support rail to secure the photovoltaic module to the at least one elongated support rail of the support structure.

14. The solar mounting system of claim 13, wherein the at least one fastener further comprises at least one projection extending in the axial direction from an underside of the fastener head and spaced radially from the threaded fastener shank, wherein the at least one projection is configured to pierce a protective coating applied to the mounting flange of the module frame in response to a tightening of the fastener so as to establish an electrical bond and grounding of the photovoltaic module with the support structure.

15. The solar mounting system of claim 13, wherein the mounting flange of the module frame includes at least one mounting aperture formed therethrough and the at least one elongated support rail includes at least one fastener aperture formed therethrough, and further wherein the at least one mounting aperture and the at least one fastener aperture are configured to receive the at least one fastener to secure the photovoltaic module to the at least one elongated support rail of the support structure

16. The solar mounting system of claim 13, wherein the at least one elongated support rail comprises a Z-shaped purlin.

17. The solar mounting system of claim 14, further comprising a plurality of projections extending in the axial direction from the underside of the at least one fastener head and spaced radially from the threaded fastener shank.

18. The solar mounting system of claim 17, wherein the plurality of projections are spaced from each other in a circumferential direction.

19. The solar mounting system of claim 18, wherein the plurality of projections are equally spaced radially from the threaded fastener shank.

20. The solar mounting system of claim 17, wherein one or more of the plurality of projections are inequally spaced radially from the threaded fastener shank.

21. The solar mounting system of claim 13, wherein the threaded fastener shank is threaded along its entire length.

22. The solar mounting system of claim 13, wherein the threaded fastener shank included a threaded portion and an unthreaded portion along its length.

23. The solar mounting system of claim 13, wherein the fastener head includes a partially circular circumference extending between a pair of opposite ends of the partially circular circumference.

24. The solar mounting system of claim 23, wherein the at least one abutment surface extends between the pair of opposite ends of the partially circular circumference.

25. The solar mounting system of claim 23, wherein the at least one abutment surface extends linearly between the pair of opposite ends of the partially circular circumference.

26. The solar mounting system of claim 13, wherein the at least one fastener comprises:
a fastener bolt; and
a collar nut configured to engage the bolt to apply a tightening force to the fastening bolt so that the at least one projection pierces the non-conductive coating applied to the mounting flange of the module frame to establish the electrical bond and grounding of the photovoltaic module with the support structure.

27. A method of installing a solar mounting system, comprising:
mounting a support structure of the solar mounting system on a base surface, the support system including a plurality of support members and at least one elongated support rail operatively supported by the plurality of support members;
securing at least one photovoltaic module having a module frame including a mounting flange and an upstanding mounting box to the at least one elongated support rail with at least one fastener,
wherein the at least one fastener comprises:
a fastener head having at least one abutment surface, wherein the at least one abutment surface is configured to engage the upstanding mounting box of the module frame in response to a rotational force being applied to the fastener so that the engagement of the at least one abutment surface with the upstanding box prevents rotation of the fastener; and
a threaded fastener shank extending in an axial direction from the fastener head and being configured to extend through the mounting flange of the at least one photovoltaic module and the at least one elongated support rail to secure the photovoltaic module to the at least one elongated support rail of the support structure.

28. The method of claim 27, wherein the at least one fastener further comprises at least one projection extending in the axial direction from an underside of the fastener head and spaced radially from the threaded fastener shank, wherein the at least one projection is configured to pierce a protective coating applied to the mounting flange of the module frame in response to a tightening of the fastener so as to establish an electrical bond and grounding of the photovoltaic module with the support structure.

29. The method of claim 27, wherein the fastener head includes a partially circular circumference extending between a pair of opposite ends of the partially circular circumference.

30. The method of claim 29, wherein the at least one abutment surface extends between the pair of opposite ends of the partially circular circumference.

31. The method of claim 30, wherein the at least one abutment surface extends linearly between the pair of opposite ends of the partially circular circumference.

32. The method of claim 27, wherein the at least one fastener comprises:
a fastener bolt; and
a collar nut configured to engage the bolt to apply a tightening force to the fastening bolt so that the at least one projection pierces the protective coating applied to the mounting flange of the module frame to establish the electrical bond and grounding of the photovoltaic module with the support structure.
